(19) United States
(12) Patent Application Publication
(10) Pub. No.: US 2024/0212490 A1
(43) Pub. Date: Jun. 27, 2024

(54) TRAFFIC INTERSECTION VEHICLE PRESENCE DETECTOR AND VIDEO RECORDER

(71) Applicant: Panasonic Automotive Systems Company of America, Division of Panasonic Corporation of North America, PEACHTREE CITY, GA (US)

(72) Inventor: BARRY EDWARD MARTIN, PEACHTREE CITY, GA (US)

(21) Appl. No.: 18/534,352

(22) Filed: Dec. 8, 2023

Related U.S. Application Data
(60) Provisional application No. 63/434,802, filed on Dec. 22, 2022.

(51) Int. Cl. G08G 1/07; G01S 13/86; G01S 13/91; G06V 20/54; G08G 1/04; H04N 7/18; H04N 23/13

(52) U.S. Cl. CPC G08G 1/07; G01S 13/867; G01S 13/91; G06V 20/54; G08G 1/04; H04N 7/181; H04N 23/13

(57) ABSTRACT

A control arrangement for a traffic light includes at least one video camera and at least one thermal imager, both detecting whether there is a motor vehicle in the lane of the roadway approaching the traffic light. An electronic processor is communicatively coupled to the at least one video camera and to the at least one thermal imager. The electronic processor receives a video signal from at least one video camera indicative of whether there is a motor vehicle in a lane of a roadway approaching the traffic light. The electronic processor also receives a thermal signal from at least one thermal imager indicative of whether there is a motor vehicle in a lane of a roadway approaching the traffic light. The electronic processor controls whether the traffic light is ON or OFF dependent upon both the video signal and the thermal signal.

### CROSS-REFERENCED TO RELATED APPLICATIONS

This application claims benefit of U.S. Provisional Application No. 63/434,802, filed on Dec. 22, 2022, the disclosure of which is hereby incorporated by reference in its entirety for all purposes.

### BACKGROUND OF THE INVENTION

### 1. Field of the Invention

The present invention relates to controlling traffic lights.

### 2. Description of the Related Art

Currently, magnetic loops are embedded into the pavement at intersections in multiple lanes in order to detect the presence of vehicles at the intersections. A problem is that the magnetic loops become damaged and need to be dug up and replaced every ten years, or more frequently in northern climates. Another problem is that motorcycles do not have enough metal to trigger detection by magnetic loops.

It is also known for video cameras to be used to detect the presence of vehicles at intersections. However, such video cameras do not work well in rain, snow, and other precipitation. After a thunderstorm, reflections on wet pavement can have a blinding effect in visual cameras. Nighttime detection is difficult for vehicles that do not have their lights on.

### SUMMARY OF THE INVENTION

The invention may provide a module that attaches to a traffic light assembly at a street intersection, road junction, or crosswalk. The module may include a visual camera, an infrared camera, a radar module, and a Wi-Fi transceiver (or any wireless interface of sufficient bandwidth that is capable of transmitting video as well as command and control information). Another module includes a Wi-Fi receiver mounted in the street intersection control box. The invention may visually, thermally, and with radar, detect vehicles waiting at an intersection. This vehicle presence information may be transmitted to the receiver in the control box to signal the controller that vehicles are present at the intersection. Additionally, cameras can stream live visual/thermal video via Wi-Fi (or any wireless interface of sufficient bandwidth that is capable of transmitting video) to the control box receiver. The receiver can be equipped with an Ethernet (or any standard hardwired streaming interface) output to stream intersection video to remote web servers.

An advantage of the invention is that the combination of cameras and radar can work in any weather conditions that current visual-only solutions cannot handle. The invention may eliminate the need for magnetics loops and the associated pavement tear-up and replacement.

The invention comprises, in one form thereof, a control arrangement for a traffic light, including at least one video camera detecting whether there is a motor vehicle in a lane of a roadway approaching the traffic light, and at least one thermal imager detecting whether there is a motor vehicle in the lane of the roadway approaching the traffic light. An electronic processor is communicatively coupled to at least one video camera and to at least one thermal imager. The electronic processor receives a video signal from at least one video camera indicative of whether there is a motor vehicle in a lane of a roadway approaching the traffic light. The electronic processor also receives a thermal signal from at least one thermal imager indicative of whether there is a motor vehicle in a lane of a roadway approaching the traffic light. The electronic processor controls whether the traffic light is ON or OFF dependent upon both the video signal and the thermal signal.

The invention comprises, in another form thereof, a control method for a traffic light, including using at least one video camera to detect whether there is a motor vehicle in a lane of a roadway approaching the traffic light. At least one thermal imager is used to detect whether there is a motor vehicle in the lane of the roadway approaching the traffic light. A video signal is received from at least one video camera indicative of whether there is a motor vehicle in a lane of a roadway approaching the traffic light. A thermal signal is received from at least one thermal imager indicative of whether there is a motor vehicle in a lane of a roadway approaching the traffic light. Whether the traffic light is ON or OFF is controlled dependent upon both the video signal and the thermal signal.

The invention comprises, in yet another form thereof, a control arrangement for a traffic light, including at least one video camera coupled to a bottom of the traffic light. The video camera detects whether there is a motor vehicle in a lane of a roadway approaching the traffic light. At least one thermal imager is coupled to the bottom of the traffic light and detects whether there is a motor vehicle in the lane of the roadway approaching the traffic light. A control box module is disposed beside the roadway and is communicatively coupled to at least one video camera and to at least one thermal imager. The control box module receives a video signal from at least one video camera indicative of whether there is a motor vehicle in a lane of a roadway approaching the traffic light. The control box module receives a thermal signal from at least one thermal imager indicative of whether there is a motor vehicle in a lane of a roadway approaching the traffic light. The control box controls whether the traffic light is ON or OFF dependent upon both the video signal and the thermal signal.

The invention comprises, in yet another form thereof, a control arrangement for a traffic light, including at least one radar detector coupled to a bottom of the traffic light. The radar detector detects whether there is a motor vehicle in a lane of a roadway approaching the traffic light based on a proposed location of a magnetic loop input to the camera's field of view. At least one camera, visual or thermal imager is coupled to the bottom of the traffic light and detects whether there is a motor vehicle in the lane of the roadway approaching the traffic light. A control box module is disposed beside the roadway and is communicatively coupled to at least one video camera and to at least one radar detector. The control box module receives a video signal from at least one video camera or radar detector indicative of whether there is a motor vehicle in a lane of a roadway approaching the traffic light. The control box module receives a command signal from at least one radar detector indicative of whether there is a motor vehicle in a lane of a roadway approaching the traffic light. The control box controls whether the traffic light is ON or OFF dependent upon either the video signal or the radar detector signal.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a block diagram of one embodiment of an intersection vehicle presence detection arrangement of the present invention.

FIG. 2 is a plan view of the traffic light module and traffic lights of the intersection vehicle presence detection arrangement of FIG. 1.

FIG. 3 is a flow chart of one embodiment of a control method of the present invention for a traffic light.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

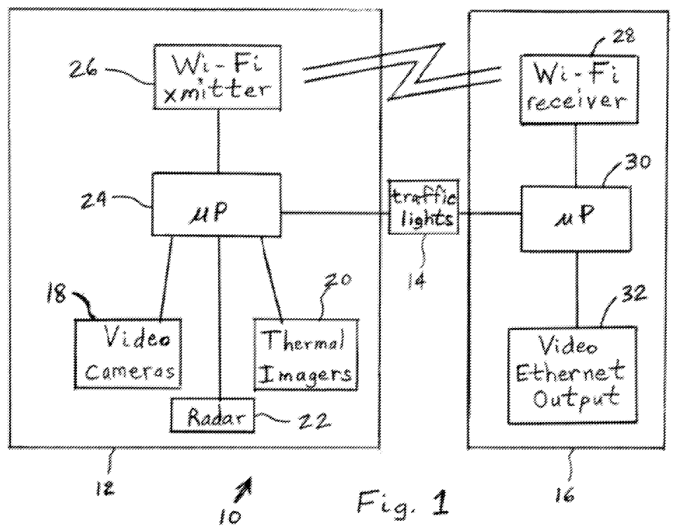

FIG. 1 illustrates one embodiment of an intersection vehicle presence detection arrangement 10 of the present invention, including a traffic light module 12, traffic lights 14, and control box module 16. Traffic light module 12 includes visual cameras 18, infrared cameras 20, radar-based vehicle detectors 22, an electronic processor 24, and a Wi-Fi transmitter 26. Control box module 16 includes a Wi-Fi receiver 28, an electronic processor 30, and a video Ethernet output 32. Wi-Fi transmitter 26 may operate at 2.4 GHz in order to communicate with Wi-Fi receiver 28 in the control box.

A respective video camera 18 and a respective infrared camera 20 may be provided for each lane in each direction (e.g., for each approaching roadway) that traffic lights 14 face. Because there may typically be one to four approaching lanes on a roadway, there may be one to four video cameras 18 and one to four infrared cameras 20 facing each approaching roadway. Each video camera 18 and each respective infrared camera 20 monitoring a same lane may be optically aligned with each other. Each infrared camera 20 may include a high purity germanium lens exposed due to the wavelength of infrared energy being detected.

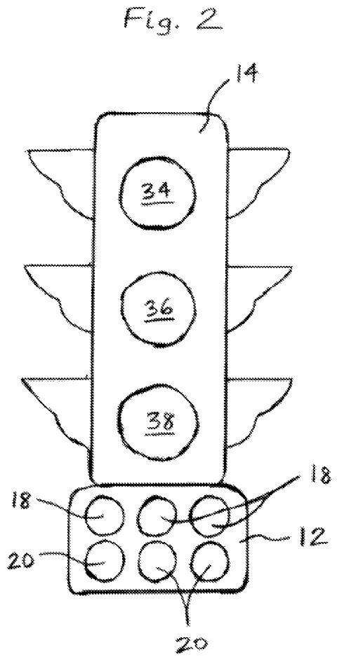

FIG. 2 illustrates traffic light module 12 attached to the bottom of traffic lights 14 of intersection vehicle presence detection arrangement 10. As is conventionally known, traffic lights 14 include a red light 34, a yellow light 36 and a green light 38.

During use, Ficosa Dense Slam software IP can be utilized for sway compensation as well as traffic detection in each viewed lane. Dense-SLAM algorithms can be tailored to provide accurate traffic flow information in real-time.

Based on inputs from video camera 18 and thermal imager 20, processor 24 may determine whether a vehicle is present in a lane, or whether the lane is empty. Local processor 24 may transmit a signal via transmitter 26 and receiver 28 to remote processor 30 that indicates whether a vehicle is present in the lane. Either local processor 24 or remote processor 30 may control the turning ON and turning OFF of traffic lights 14 based on the presence or absence of vehicles in the various approaching lanes. However, local processor 24 controlling the turning ON and turning OFF of traffic lights 14 may require less wiring.

Firmware upgrades may be made over the air via an Ethernet/Internet/wireless interface. Bluetooth capability may enable commissioning and configuration of each system remotely, i.e., by an installer at the corner of the intersection via a phone app.

Radar sensor 22 or a Lidar sensor may be provided on the bottom of module 12 to sense the presence of vehicles in the event of camera failures. This addition may make the traffic light act similarly to adaptive cruise control whereby the front camera coordinates the radar beam to the lane the vehicle is currently in with other vehicles in front of the vehicle in that lane.

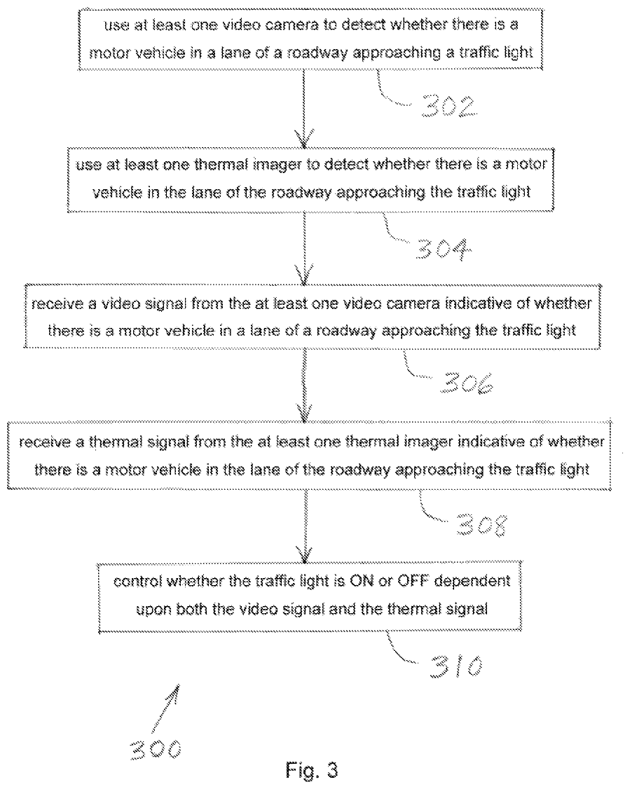

FIG. 3 is a flow chart of one embodiment of a control method 300 of the present invention for a traffic light. In a first step 302, at least one video camera is used to detect whether there is a motor vehicle in a lane of a roadway approaching the traffic light. For example, video camera 18 captures images of a lane of a roadway approaching traffic lights 14 and thereby detects any motor vehicle in the lane of the roadway.

Next, in step 304, at least one thermal imager is used to detect whether there is a motor vehicle in the lane of the roadway approaching the traffic light. For example, infrared camera 20 may capture images of the same lane of a roadway approaching traffic lights 14 that video camera 18 monitors in step 302. Thereby, infrared camera 20 may detect any motor vehicle in the lane of the roadway.

In a next step 306, a video signal is received from the at least one video camera wherein the signal is indicative of whether there is a motor vehicle in a lane of a roadway approaching the traffic light. For example, video camera 18 may transmit a video signal that is indicative of whether there is a motor vehicle in the lane of the roadway approaching the traffic light. The video signal may be received by processor 24.

In step 308, a thermal signal is received from the at least one thermal imager wherein the signal is indicative of whether there is a motor vehicle in a lane of a roadway approaching the traffic light. For example, infrared camera 20 may transmit a thermal signal that is indicative of whether there is a motor vehicle in the lane of the roadway approaching the traffic light. The thermal signal may be received by processor 24.

In a final step 310, it is controlled whether the traffic light is ON or OFF, the controlling being dependent upon both the video signal and the thermal signal. For example, local processor 24 may control the turning ON and turning OFF of traffic lights 14 based on the presence or absence of vehicles in the various approaching lanes, as indicated by the video signal and the thermal signal. As a specific example, processor 24 may continue to cause traffic light 14 to present a green light in a particular direction so long as vehicles approaching the green light continue to be detected by either video camera 18 or infrared camera 20.

In another embodiment, video signals from the traffic light cameras are streamed via Wi-Fi (or video capable wireless protocol) to the control box receiver and provided via cloud services to anyone who wants to view it, such as a traffic authority or news organization. Facilitating this embodiment, control boxes at each intersection typically have Ethernet capability to the internet.

In yet another embodiment, the invention detects trains approaching an intersection, and controls automated gates or flashing lights to alert drivers of the approaching train.

In a further embodiment, the invention is used for traffic monitoring on highways with cell connections to provide real-time traffic condition updates with a cloud interface for traffic apps such as WAYS. Thus, the invention may be used to count traffic flow on interstates.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A control arrangement for a traffic light, the arrangement comprising:
at least one video camera positioned and configured to detect whether there is a motor vehicle in a lane of a roadway approaching the traffic light;
at least one thermal imager positioned and configured to detect whether there is a motor vehicle in the lane of the roadway approaching the traffic light; and
an electronic processor communicatively coupled to the at least one video camera and to the at least one thermal imager, the electronic processor being configured to:
receive a video signal from the at least one video camera indicative of whether there is a motor vehicle in a lane of a roadway approaching the traffic light;
receive a thermal signal from the at least one thermal imager indicative of whether there is a motor vehicle in a lane of a roadway approaching the traffic light; and
control whether the traffic light is ON or OFF dependent upon both the video signal and the thermal signal.

2. The arrangement of claim 1 wherein the at least one video camera and the at least one thermal imager are each configured to be coupled to a bottom of the traffic light.

3. The arrangement of claim 1 wherein the traffic light includes a red light, a yellow light and a green light, the electronic processor being configured to control whether each of the red light, the yellow light and the green light is ON or OFF dependent upon both the video signal and the thermal signal.

4. The arrangement of claim 1 wherein the at least one video camera comprises a plurality of video cameras, each said video camera being configured to detect whether there is a motor vehicle in a respective lane of a roadway approaching the traffic light from a corresponding direction, and the at least one thermal imager comprises a plurality of thermal imagers, each said thermal imager being configured to detect whether there is a motor vehicle in a respective lane of a roadway approaching the traffic light from a corresponding direction.

5. The arrangement of claim 1 further comprising at least one radar-based vehicle detector positioned and configured to detect whether there is a motor vehicle in a lane of a roadway approaching the traffic light, the electronic processor being communicatively coupled to the at least one radar-based vehicle detector, the electronic processor being configured to:
receive a radar signal from the at least one radar-based vehicle detector indicative of whether there is a motor vehicle in a lane of a roadway approaching the traffic light; and
control whether the traffic light is ON or OFF dependent upon the radar signal.

6. The arrangement of claim 1 further comprising a Wi-Fi transmitter configured to receive and wirelessly transmit the video signal.

7. The arrangement of claim 6 wherein the Wi-Fi transmitter is configured to receive and wirelessly transmit the radar signal.

8. A control method for a traffic light, the method comprising:
using at least one video camera to detect whether there is a motor vehicle in a lane of a roadway approaching the traffic light;
using at least one thermal imager to detect whether there is a motor vehicle in the lane of the roadway approaching the traffic light;
receiving a video signal from the at least one video camera indicative of whether there is a motor vehicle in a lane of a roadway approaching the traffic light;
receiving a thermal signal from the at least one thermal imager indicative of whether there is a motor vehicle in a lane of a roadway approaching the traffic light; and
controlling whether the traffic light is ON or OFF, the controlling being dependent upon both the video signal and the thermal signal.

9. The method of claim 8 further comprising coupling the at least one video camera and the at least one thermal imager to a bottom of the traffic light.

10. The method of claim 8 wherein the traffic light includes a red light, a yellow light and a green light, the controlling step including controlling whether each of the red light, the yellow light and the green light is ON or OFF dependent upon both the video signal and the thermal signal.

11. The method of claim 8 wherein the at least one video camera comprises a plurality of video cameras, each said video camera being used to detect whether there is a motor vehicle in a respective lane of a roadway approaching the traffic light from a corresponding direction, and the at least one thermal imager comprises a plurality of thermal imagers, each said thermal imager being used to detect whether there is a motor vehicle in a respective lane of a roadway approaching the traffic light from a corresponding direction.

12. The method of claim 8 further comprising:
using at least one radar-based vehicle detector to detect whether there is a motor vehicle in a lane of a roadway approaching the traffic light;
receiving a radar signal from the at least one radar-based vehicle detector indicative of whether there is a motor vehicle in a lane of a roadway approaching the traffic light; and
controlling whether the traffic light is ON or OFF dependent upon the radar signal.

13. The method of claim 8 further comprising using a Wi-Fi transmitter to receive and wirelessly transmit the video signal.

14. The method of claim 13 further comprising using the Wi-Fi transmitter to receive and wirelessly transmit the radar signal.

15. A control arrangement for a traffic light, the arrangement comprising:
at least one video camera configured to:
be coupled to a bottom of the traffic light; and
detect whether there is a motor vehicle in a lane of a roadway approaching the traffic light;
at least one thermal imager configured to:
be coupled to the bottom of the traffic light; and
detect whether there is a motor vehicle in the lane of the roadway approaching the traffic light; and
a control box module disposed beside the roadway, the control box module being communicatively coupled to the at least one video camera and to the at least one thermal imager, the control box module being configured to:
receive a video signal from the at least one video camera indicative of whether there is a motor vehicle in a lane of a roadway approaching the traffic light;
receive a thermal signal from the at least one thermal imager indicative of whether there is a motor vehicle in a lane of a roadway approaching the traffic light; and
control whether the traffic light is ON or OFF dependent upon both the video signal and the thermal signal.

16. The arrangement of claim 15 wherein the at least one video camera and the at least one thermal imager are each configured to be coupled to a bottom of the traffic light.

17. The arrangement of claim 15 wherein the traffic light includes a red light, a yellow light and a green light, the control box module being configured to control whether each of the red light, the yellow light and the green light is ON or OFF dependent upon both the video signal and the thermal signal.

18. The arrangement of claim 15 wherein the at least one video camera comprises a plurality of video cameras, each said video camera being configured to detect whether there is a motor vehicle in a respective lane of a roadway approaching the traffic light from a corresponding direction, and the at least one thermal imager comprises a plurality of thermal imagers, each said thermal imager being configured to detect whether there is a motor vehicle in a respective lane of a roadway approaching the traffic light from a corresponding direction.

19. The arrangement of claim 15 further comprising at least one radar-based vehicle detector positioned and configured to detect whether there is a motor vehicle in a lane of a roadway approaching the traffic light, the control box module being communicatively coupled to the at least one radar-based vehicle detector, the control box module being configured to:
receive a radar signal from the at least one radar-based vehicle detector indicative of whether there is a motor vehicle in a lane of a roadway approaching the traffic light; and
control whether the traffic light is ON or OFF dependent upon the radar signal.

20. The arrangement of claim 15 further comprising:
a first Wi-Fi transmitter disposed in association with the video camera and with the thermal imager, the first Wi-Fi transmitter being configured to receive and wirelessly transmit the video signal and the radar signal; and
a second Wi-Fi transmitter disposed in association with the control box module, the second Wi-Fi transmitter being configured to wirelessly receive and transmit the video signal and the radar signal to the control box module.
